(19) United States
(12) Patent Application Publication
(10) Pub. No.: US 2012/0206114 A1
(43) Pub. Date: Aug. 16, 2012

(54) Method and device for operating a solar cell assembly

(75) Inventor: Wolfgang Volz, Ostfildern (DE)

(73) Assignee: Robert Bosch GMBH, Stuttgart (DE)

(21) Appl. No.: 13/389,728

(22) PCT Filed: Jul. 20, 2010
(86) PCT No.: PCT/EP10/60500

§ 371 Date: Apr. 20, 2012

(30) Foreign Application Priority Data
Aug. 10, 2009 (DE) 102009028403.6

(51) Int. Cl. G05F 1/70

(52) U.S. Cl. 323/207

(57) ABSTRACT

A method is described for operating a solar cell assembly, particularly having solar cells that are organically based for power output from it, wherein an electric power output is controlled according to a specified time program, or at least one state variable of the solar cell assembly is monitored in a time-dependent manner, and the output electric power is controlled as a function of recorded measured values of the state variable.

### FIELD OF THE INVENTION

The present invention relates to a method for operating solar cell assembly and to a device for implementing the method.

### BACKGROUND INFORMATION

Among so-called regenerative energies, solar energy is gaining in importance to the extent that it has been successful in lowering the costs of the solar cell modules and the entire assemblies, and in increasing the energy yield, and thus in approaching in value, on an overall basis, the costs per unit of electrical energy produced which set the economic standard in energy production based on fossil fuels. Besides the photoelectric yield of the individual cell, what is also important is a suitable operating mode, especially an optimized mode of outputting the electrical energy.

The power withdrawal in organic solar cells takes place continuously, since the power depends only on external parameters, such as irradiation and temperature. The power withdrawal therefore takes place using a so-called maximum power point tracker, which withdraws the power invariantly in time. This procedure and a corresponding circuit arrangement are discussed in EP 1 239 576 A2.

### SUMMARY OF THE INVENTION

In this document, it is proposed that one get away from previously applied operating methods, in which perhaps the pulse control factor of a switch converter is set as a function of the measured values of continuously carried out voltage and current measurements and subsequent A/D conversion, or the pulse duty factor is tracked during the monitoring of the switch converter output in such a way that the output voltage or output current is maximized, in the interest of simplified control.

In this context, it has been recognized that, based on the efficiency over time and the efficiency depending on the state in the SDSC, that a suboptimal power withdrawal comes about, and the potential of the cell is not completely exhausted. This results in power losses.

The exemplary embodiments and/or exemplary methods of the present invention are therefore based on the object of providing an improved method for operating a solar cell assembly, particularly having solar cells that are organically based, and of providing an assembly for carrying out the method, which make possible achieving a higher energy yield over a longer operating duration.

This object is attained in its method aspect by a method having the features described herein and in its device aspect by an assembly having the features described herein. Expedient refinements of the idea of the present invention are the subject matter of the further descriptions herein.

The exemplary embodiments and/or exemplary methods of the present invention include the essential idea of getting away from the working principle, practiced up to now, of “maximum power point tracking”, in which the power provided is withdrawn in a manner constant over time. Furthermore, it includes the idea of matching the control over time of the power output in a suitable manner to the determined variance over time of the electrical power parameters, of certain types of solar cell assemblies—special organic solar cells, and even more especially, those of the SDSC type.

To do this, according to a first aspect of the exemplary embodiments and/or exemplary methods of the present invention, a specified time program of the power output is ascertained, and then a corresponding time control is applied or, according to a second aspect of the exemplary embodiments and/or exemplary methods of the present invention, a decisive state variable of the solar cell assembly is monitored as a function of time and the power control is carried out as a function of the measuring result. It should be understood that the assembly provided should reflect these method fundamentals in the form of structural features, that is, device aspects.

Thus, the exemplary embodiments and/or exemplary methods of the present invention take into account the internal variance over time of organic solar cells. Because of this, the cell is able to be operated over longer time periods at a higher power point, and the potential of the cell is exhausted in optimum fashion.

In one specific embodiment of the present invention, it is provided that the electric power that is output is periodically reduced for a predetermined time span and by a predetermined amount, compared to a maximum power value. In particular, in this connection, the periodic reduction may be carried out in a manner connected with a time of day, especially as an overnight lowering of the power that is output. Even apart from the principle of the overnight lowering, the time control program may be designed in such a way that, in a correspondingly operated photovoltaic system, the maximum power is provided at peak usage times, while the power output is reduced in time sections of lower requirement.

In this connection it is also possible briefly to modify the time control of the power output, so as to take care of a possible shifting of load peaks on a contemporary basis.

Within this meaning, by specified time program one should not understand a long-term and unchangeable predetermined program, but usage-adapted, short-term control interventions should definitely be within the scope of the present invention, provided the medium-term control of the power output is adapted to the physical circumstances of the respective solar cell structure.

In one further embodiment of the present invention it is provided that the electric power output, by temporary switching over the operating voltage, is controlled to a suitable value for the regeneration of the solar cell assembly, particularly to its idling voltage. The suitable voltage value does not necessarily or even may have to be the idling voltage, but rather, from the design of the respective solar cell or from the boundary conditions of the controller other values may also come about as being suitable.

In another suitable embodiment of the present invention, the output electric power itself is monitored as the state variable, and its recorded measured value is used to control the output. This specific embodiment thus has a feedback aspect and represents a regulation, in a certain sense. But basically, other state variables also come into consideration as the initial basis for the control, which are in sufficiently direct relationship to the mechanisms of the charge carrier generation and the power output to an outside load. This may be, perhaps, a local rise or section-wise curve of an output current/output voltage characteristic curve, a surface temperature of the solar cell or the like.

One specific embodiment of the assembly provided is designed so that the sensor is developed as a power measuring unit for detecting the output charge, especially its instantaneous value.

In a still further embodiment, it is provided that, between the sensor and the control device a threshold value discriminator is connected, in such a way that the input signal output by the sensor for the control device is a function of the exceeding or the falling below of at least one specified threshold value of the state variable. In the threshold value discriminator, among other things, a lower threshold value may be implemented, so that the power controller responds to a lowering of the current power (in the operating mode of maximum output).

In one design of this embodiment, the threshold value discriminator may be designed in a multi-step manner, so that as a function of which of several specified threshold values is reached under certain conditions in “maximum operation”, a different control program of several selectable ones is activated in each case. Even in the transition from the operating mode having reduced power output back to the “maximum operation”, a multi-step discriminator is able to function meaningfully, in that, as a function of the actually reached recovery state of the solar cells, either the maximum power point tracking is taken up again without restriction, or an operation mode having moderately increased power output is set.

For the above-mentioned and additional embodiments, a processor control of the switching control unit having an internal or permanently connected control program memory for storing a plurality of control programs in association with certain input values is advantageous. The control programs may be provided to be permanently programmed or externally, if necessary, via a wire-bound or wireless message transmission from a control station to the solar cell assembly, or may be changeable.

Advantages and useful points of the exemplary embodiments and/or exemplary methods of the present invention also follow from the following detailed description, in light of the figures.

### BRIEF DESCRIPTION OF THE DRAWINGS

FIGS. 1A and 1B show an exemplary embodiment of the method of the present invention in a graphic illustration of the curve over time of the voltage present at a solar cell assembly and the power that is output.

FIGS. 2A and 2B show schematic representations for illustrating an assembly according to the invention.

FIG. 3 shows a schematic representation of a further embodiment of the assembly according to the present invention.

FIG. 4 shows a schematic representation of another specific embodiment of the present invention.

### DETAILED DESCRIPTION

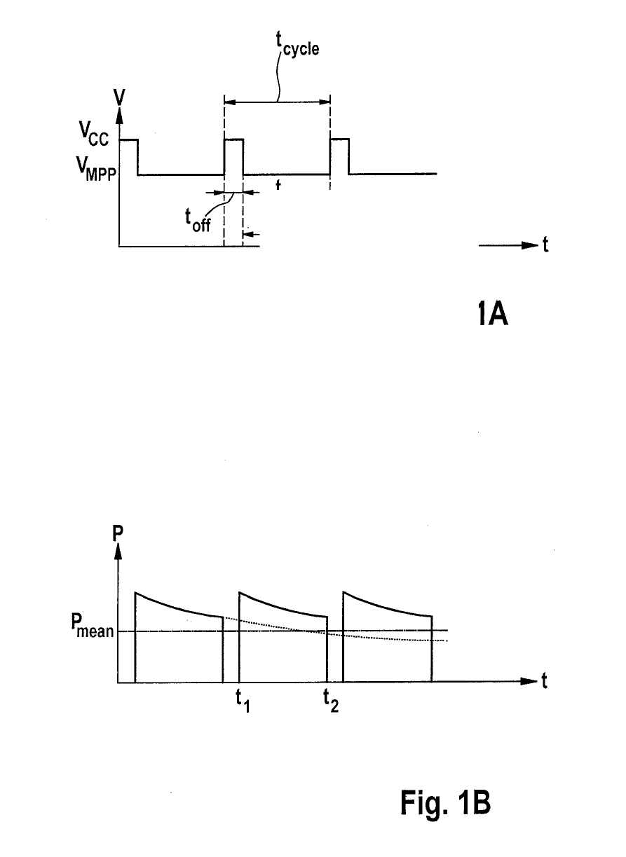

Instead of drawing continuous power in the maximum power point (V_{MPP}) from the organic solar cells (OPV) and to ignore a reduction in power with time, the controller switches over the working point after a certain time tₒₙ from the optimum working point to a regeneration point, so that the cell is able to recover, cf. FIGS. 1A and 1B. The efficiency is thereby lifted to a maximum again. This regeneration point is, in particular, the idling voltage (V_{OC}). At this regeneration point no current is flowing, and thus no power is implemented. After a recovery phase t_{off}, the working point is placed in optimum working point (V_{MPP}) again.

In FIG. 1B, dotted or dashed lines show for comparison how the curve over time of the output power (average value) turns out in the provided operating mode, compared to the usual mode (without the periodic resetting of the operating voltage. One may see that the average power that is able to be output, shown by a dash-dotted line, is higher in the method guidance according to the present invention.

The length of the recovery phase is variable, and it may take place during parts of, or the whole night, for example. Based on the prior recovery phase, the cell supplies maximum power. The controller is able to react optimally because of external inputs (tₒₙ, t_{off}) to the power reduction of the cell with time. However, by the analysis of power varying with time and the adjustment of the switching duration, without external input, the controller is also able to calculate the best possible ratio of the on and off states.

On average, the power produced by the switching processes is higher than that produced according to conventional methods. bIt is true that, because of the regeneration phases, no power loss takes place, but, because of the higher operating state, this power loss may be overcompensated for. The efficiency η is thus calculated correspondingly as:

$$η = \frac{{P}_{out} ( t )}{{P}_{in} ( t )} = \frac{{\int }_{cycle} {P}_{out} ( t ) d t}{{P}_{in} {t}_{cycle}}$$

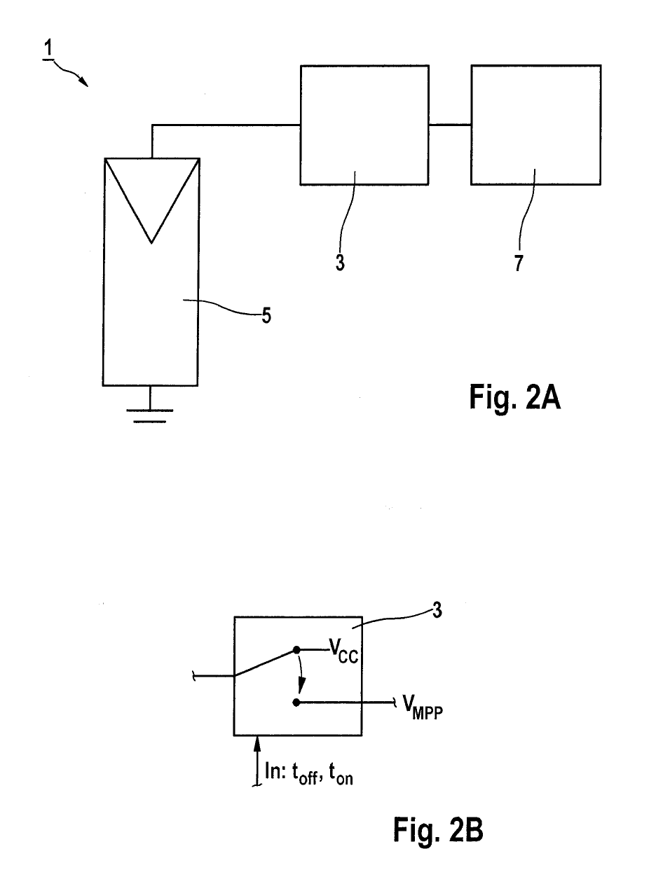

In a sketched representation, FIG. 2A shows a solar cell assembly 1, in which a control device 3 is connected between a solar cell module 5 (whose other terminal is at ground) and a switch converter unit/load 7, which control device 3 (in a manner known per se) may especially include a so-called MPP tracker and a DC/AC converter. FIG. 2B shows schematically how control device 3 is able to switch the voltage level from V_{OC} to V_{MMP} and back, and (optionally) receive and process switch periods t_{off} and tₒₙ as external input signals.

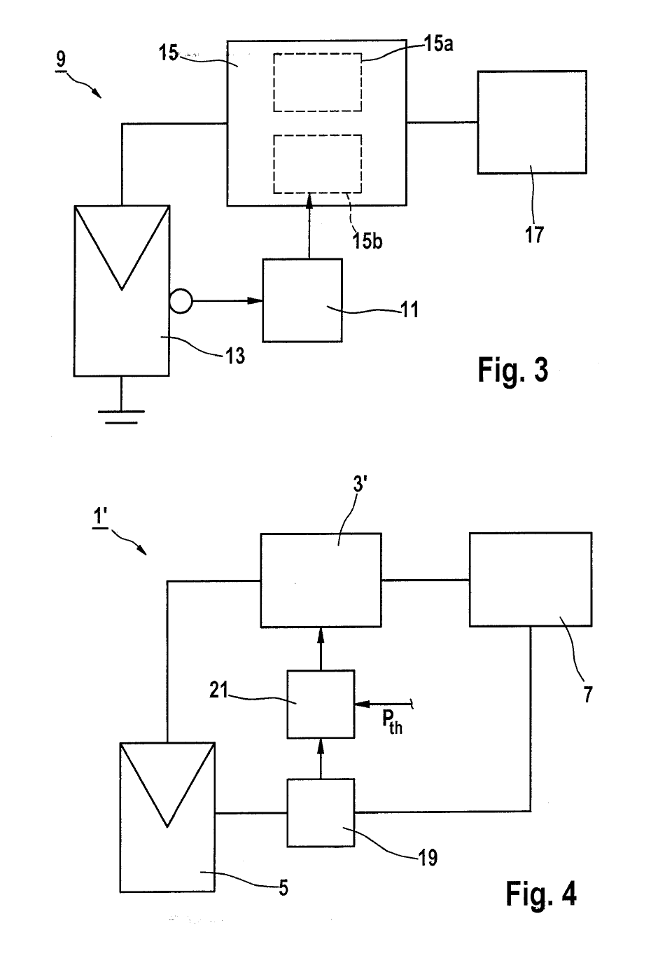

FIG. 3 shows in a sketched manner an additional solar cell assembly 9, in which a temperature sensor 11 detects a surface temperature of a solar cell module 13, and provides the measuring signal as an input variable of a control device 15 which, here too, is connected between solar cell module 13 and switch converter unit 17. Control device 15 includes a microcontroller 15a and a control program memory 15b, which is addressed via the input signal obtained by temperature sensor 11, and from which a suitable control program is read out in response to the input variable and activated.

Finally, FIG. 4 shows schematically a modification of the first specific embodiment shown in FIG. 2A and described farther above, in which the power, that is output, of solar cell module 5 is recorded by a power measuring module 19 and the measuring result is supplied to a threshold value discriminator 21. The latter performs a threshold value discrimination of the recorded power value with respect to a prestored lower threshold value, and when the latter is undershot, it passes on a corresponding control signal to an input of (modified) control device 3′, which there effects the activation of a regeneration control mode of the assembly. As long as the disposable power does not reach the lower threshold value or undershoot it, the assembly may be operated in “maximum power point”.

The configurations of the exemplary embodiments and/or exemplary methods of the present invention are not limited to the above-described examples and aspects, but rather may be possible in a multitude of modifications lying within the framework of the actions of a professional. It is also pointed out expressly that the operating mode provided is not limited to solar cells of the type described, but is basically also applicable in a useful manner in photovoltaic systems of other types, as well as other direct voltage sources.

1-10. (canceled)

11. A method for operating a solar cell assembly, which includes solar cells that are organically based, for providing electric power output from it, the method comprising:
one of controlling the electric power output according to a specified time program, and monitoring at least one state variable of the solar cell assembly in a time-dependent manner, the electric power output being controlled as a function of recorded measured values of the state variable.

12. The method of claim 11, wherein the electric power that is output is respectively periodically reduced for a predetermined time span and by a predetermined amount, as compared to a maximum power value.

13. The method of claim 12, wherein the periodic reduction is performed in a manner connected with a time of day, including as an overnight lowering of the power that is output.

14. The method of claim 11, wherein the electric power output is controlled by temporarily reducing the operating voltage to a suitable value for the regeneration of the solar cell assembly, which includes its idling voltage.

15. The method of claim 11, wherein the electric power output is monitored as the state variable, and its recorded measured value is used to control the output.

16. The method of claim 11, wherein the time dependence of the state variable is detected by scanning at equal intervals.

17. A system, comprising:
a control arrangement, including:
a control device for controlling in time the output electric power, in which a control program is implemented; and
at least one of a timer connected to the control device on the input side, and a sensor connected to the control device on the input side for the time-dependent recording of the state variable and for outputting a signal to the control device that represents the recording result;
wherein the control arrangement is operable for operating a solar cell assembly, which includes solar cells that are organically based, for providing electric power output from it, by performing the following: one of controlling the electric power output according to a specified time program, and monitoring at least one state variable of the solar cell assembly in a time-dependent manner, the electric power output being controlled as a function of recorded measured values of the state variable.

18. The system of claim 17, wherein the sensor is configured as a power measuring unit for detecting the power that is output, including at its instantaneous value.

19. The system of claim 17, wherein a threshold value discriminator is connected between the sensor and the control device, so that the input signal output by the sensor for the control device is a function of one of exceeding and undershooting at least one specified threshold value of the state variable.

20. The system of claim 17, wherein the control device is configured as a process-controlled switch control unit having an internal or permanently connected control program memory.
